(19) United States
(12) Patent Application Publication
(10) Pub. No.: US 2026/0147501 A1
(43) Pub. Date: May 28, 2026

(54) SYSTEMS, APPARATUSES AND METHODS FOR DETERMINING AND STORING STRESS VALUES FOR MEMORY OF A MEMORY DEVICE

(71) Applicant: Micron Technology, Inc., Boise, ID (US)

(72) Inventors: Donald M. Morgan, Meridian, ID (US); Charles L. Ingalls, Meridian, ID (US)

(73) Assignee: Micron Technology, Inc., Boise, ID (US)

(21) Appl. No.: 19/387,427

(22) Filed: Nov. 12, 2025

Related U.S. Application Data
(60) Provisional application No. 63/725,181, filed on Nov. 26, 2024.

(51) Int. Cl. G06F 3/06

(52) U.S. Cl. CPC G06F 3/0653; G06F 3/0619; G06F 3/0673

(57) ABSTRACT

A memory device stores data and stress values in one or more memory arrays. Each time a row in the memory array is accessed, one or more rows near the accessed row experience stress. The stress values represent the stress experienced by the nearby rows. Stress values associated with an accessed row and the rows near the accessed row are read out, adjusted, and stored back in the memory array. A row that is near an accessed row is refreshed when the stress value associated with that row equals or exceeds a threshold.

### CROSS-REFERENCE TO RELATED APPLICATIONS

This application claims the filing benefit of U.S. Provisional Application No. 63/725,181, filed Nov. 26, 2024. This application is incorporated by reference herein in its entirety and for all purposes.

### BACKGROUND

A memory device may include a number of memory cells that are used to store information as a physical signal, such as a charge on a capacitive element. The memory cells may be arranged in an array with the memory cells organized at the intersections of word lines (rows) and bit lines (columns). The stored information may degrade over time, which can destroy the information stored on the memory cells. In order to preserve the integrity of the stored information, the memory cells may be refreshed to restore an initial charge level associated with the stored information (e.g., on a row-by row-basis). Refresh operations and access operations, such as read operations and write operations, access rows in the memory array. However, certain access patterns, such as repeated accesses to particular rows, can cause the information stored in the memory cells near the accessed rows to decay faster.

### BRIEF DESCRIPTION OF THE DRAWINGS

Non-limiting and non-exhaustive examples are described with reference to the following Figures. The elements of the drawings are not necessarily to scale relative to each other. Identical reference numerals have been used, where possible, to designate identical features that are common to the Figures.

FIG. 1 illustrates a block diagram of an example system according to an embodiment of the disclosure;

FIG. 2 illustrates a block diagram of an example semiconductor device according to an embodiment of the disclosure;

FIG. 3 illustrates a portion of a memory array according to an embodiment of the disclosure;

FIG. 4 illustrates a block diagram of examples of a data memory array and a row stress memory array according to an embodiment of the disclosure;

FIG. 5 illustrates a block diagram of example arrangements for a data memory array and a row stress memory array according to an embodiment of the disclosure;

FIG. 6 illustrates an example row address according to an embodiment of the disclosure;

FIG. 7 illustrates different example arrangements for stress values in a portion of a row stress memory array according to an embodiment of the disclosure;

FIG. 8 illustrates another example arrangement for stress values in a row stress memory array according to an embodiment of the disclosure;

FIG. 9 illustrates a process of accessing stress values in the fourth arrangement shown in FIG. 8 according to an embodiment of the disclosure;

FIG. 10 illustrates a block diagram of an example RSMA decoder according to an embodiment of the disclosure;

FIG. 11 illustrates a block diagram of an example row stress control circuit according to an embodiment of the disclosure;

FIG. 12 illustrates a block diagram of an example refresh address generator according to an embodiment of the disclosure;

FIG. 13 illustrates a flowchart of an example method of operating a memory device according to an embodiment of the disclosure; and

FIG. 14 illustrates a flowchart of an example method of operating a memory device according to an embodiment of the disclosure.

### DETAILED DESCRIPTION

Memory cells in a memory device are positioned at the intersections of word lines and bit lines. A memory cell may be accessed, for example, for a read operation or a write operation by activating a respective word line and respective bit lines connected to that memory cell. Additionally, the word lines in the memory device can be activated during refresh operations (e.g., on a row-by-row basis). Certain access patterns, such as repeated accesses to particular rows, can adversely impact the memory cells in the rows that are proximate to the accessed rows. For example, repeated accesses to a particular row can cause the rate of decay of the information stored on the memory cells proximate to the particular row to increase.

Embodiments described herein determine stress values for one or more rows that are proximate to an accessed row (the one or more rows are also referred to as stressed rows). The stress values represent an amount of stress that is experienced by the one or more rows as a result of accessing the accessed row. In some instances, the amount of stress varies based on the proximity of a stressed row to the accessed row. For example, a stressed row that is immediately adjacent to an accessed row can experience a greater amount of stress compared to a stressed row that is one or more rows away from the accessed row.

In one embodiment, a first memory array stores data and a second memory array stores stress values. The stress values are associated with respective rows of memory in the first memory array. When a row in the first memory array is accessed, a stress value that is associated with the accessed row and a stress value for each stressed row in the first memory array are read out of the second memory array. The accessed row in the first memory array may be accessed for a variety of operations, such as a read operation, a write operation, or a refresh operation (e.g., an auto-refresh operation). An adjustment value is applied to each stress value and the adjusted stress value(s) are stored in the second memory array. A stressed row in the first memory array is refreshed when the stress value associated with that stressed row equals or exceeds a threshold. The stress value associated with that refreshed stressed row is reset to an initial stress value (e.g., zero) and the initial stress value is stored in the second memory array to replace the prior stress value associated with the stressed row. Additionally, since the access to the accessed row has the same effect on the row as a refresh operation, the stress value associated with the accessed row is reduced or reset to the initial stress value. The reduced stress value or the initial stress value is stored in the second memory array to replace the prior stress value associated with the accessed row. In some embodiments, the stress value associated with the accessed row can be reduced by subtracting a constant value from the associated stress value or writing a random stress value that is below the threshold to the second memory array. The terms first memory array and second memory array can refer to physically distinct memory arrays or to different sections within a memory array, where the first and the second memory can be concurrently accessed.

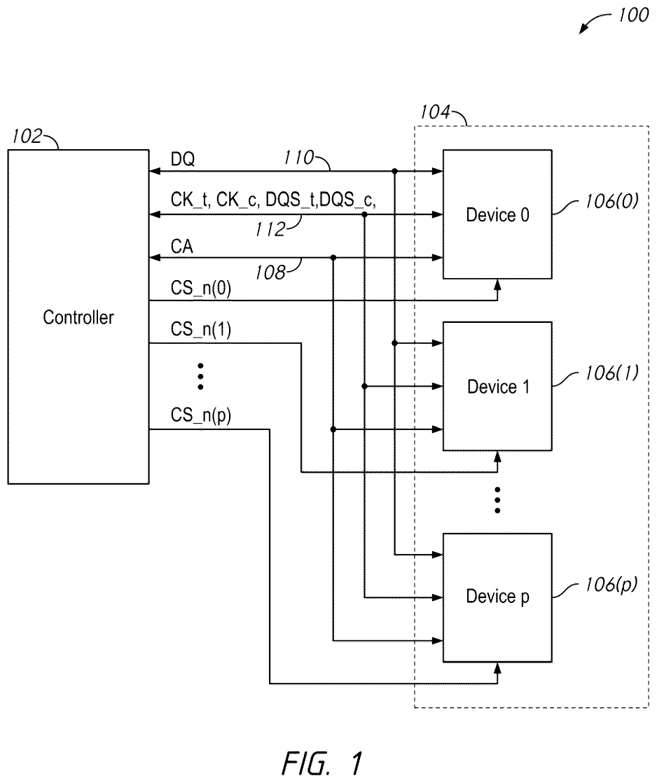

FIG. 1 illustrates a block diagram of an example system 100 according to an embodiment of the disclosure. The system 100 includes a controller 102 and a memory system 104. In the illustrated embodiment, the memory system 104 includes memory devices 106(0)-106(p) (e.g., “Device 0” through “Device p”), where p is a number greater than zero (0). The memory devices 106(0)-106(p) may include a dynamic random-access memory (DRAM), a double data rate (DDR) memory, a low power double data rate (LPDDR) memory, a graphics double data rate (GDDR) memory, or other type of memory.

The memory devices 106(0)-106(p) are each coupled to a command/address bus, a data bus, and clock busses. The controller 102 and the memory system 104 are in communication over several busses. Commands and addresses (CA) are received by the memory system 104 on the command/address bus 108, and data (DQ) is provided between the controller 102 and the memory system 104 over a data bus 110. Various clocks may be provided between the controller 102 and the memory system 104 over a clock bus 112. The clock bus 112 may include signal lines for providing system clocks CK_t and CK_c received by the memory system 104 and data clocks (strobes) DQS_t and DQS_c received and/or provided by the memory system 104 to the controller 102. Each of the busses may include one or more signal lines on which signals are provided.

The CK_t and CK_c clocks provided by the controller 102 to the memory system 104 are used for timing the provision and receipt of the commands and addresses. The DQS_t and DQS_c clocks are used for timing the provision of data. The CK_t and CK_c clocks are complementary, and the DQS_t and DQS_c clocks are complementary. Clocks are complementary when a rising edge of a first clock occurs at a same time as a falling edge of a second clock, and when a rising edge of the second clock occurs at a same time as a falling edge of the first clock.

The controller 102 provides commands to the memory system 104 to perform memory operations. Example memory commands include timing commands for controlling the timing of various operations, access commands for accessing memory, such as activate commands for performing activate operations, read commands for performing read operations, and write commands for performing write operations, as well as other commands and operations. The command signals provided by the controller 102 to the memory system 104 further include external control signals (e.g., CS_n(0), CS_n(1), CS_n(p)). All of the memory devices 106(0)-106(p) are provided the commands, addresses, data, and clocks, and the external control signals. The control signals provided on respective select signal lines are used to select which of the memory devices 106(0)-106(p) will respond to the command and perform the corresponding operation. In some embodiments, a respective control signal is provided to each memory device 106(0)-106(p) of the memory system 104. The controller 102 provides an active control signal to select the corresponding memory device 106(0)-106(p). While the respective control signal is active, the corresponding memory device 106(0)-106(p) is selected to receive the commands and addresses provided on the command/address bus 108. In some embodiments, the external control signal is used in combination with the CA signals to indicate different memory commands and memory operations.

In operation, when activate and read commands and associated address are provided by the controller 102 to the memory system 104, the memory device 106(0)-106(p) selected by the external control signals receives the activate and read commands and associated address and performs a read operation to provide the controller 102 with read data from a memory location corresponding to the associated address. The read data is provided by the selected memory device 106(0)-106(p) to the controller 102 according to a timing relative to receipt of the read command. For example, the timing may be based on a read latency (RL) value that indicates the number of clock cycles of the CK_t and CK_c clocks (a clock cycle of the CK_t and CK_c clocks is referenced as tCK) after the read command when the read data is provided by the selected memory device 106(0)-106(p) to the controller 102. The RL value is programmed by the controller 102 in the memory devices 106(0)-106(p). For example, the RL value may be programmed in respective mode registers of the memory devices 106(0)-106(p). As known, mode registers included in each of the memory devices 106(0)-106(p) may be programmed with information for setting various operating modes and/or to select features for operation of the memory devices 106(0)-106(p). One of the settings may be for the RL value.

In preparation of the selected memory device 106(0)-106(p) providing the read data to the controller 102, the memory device provides active data clocks DQS_t and DQS_c. A clock is active when the clock transitions between low and high clock levels periodically. Conversely, a clock is inactive when the clock maintains a constant clock level and does not transition periodically. The DQS_t and DQS_c clocks are provided by the memory device 106(0)-106(p) performing the read operation to the controller 102 for timing the provision of read data to the controller 102. The controller 102 may use the DQS_t and DQS_c clocks for receiving the read data.

In operation, when activate and write commands and associated address are provided by the controller 102 to the memory system 104, the memory device 106(0)-106(p) selected by the external control signals receives the activate and write commands and associated address and performs a write operation to write data from the controller 102 to a memory location corresponding to the associated address. The write data is provided to the selected memory device 106(0)-106(p) by the controller 102 according to a timing relative to receipt of the write command. For example, the timing may be based on a write latency (WL) value that indicates the number of clock cycles of the CK_t and CK_c clocks after the write command when the write data is provided to the selected memory device 106(0)-106(p) by the controller 102. The WL value is programmed by the controller 102 in the memory devices 106(0)-106(p). For example, the WL value may be programmed in respective mode registers of the memory devices 106(0)-106(p).

In preparation of the selected memory device 106(0)-106(p) receiving the write data from the controller 102, the controller 102 provides active data clocks DQS_t and DQS_c to the memory system 104. The DQS_t and DQS_c clocks may be used by the selected memory device 106(0)-106(p) to generate internal clocks for timing the operation of circuits to receive the write data. The data is provided by the controller 102 and the selected memory device 106(0)-106(p) receives the write data according to the DQS_t and DQS_c clocks, which is written to a memory location corresponding to the memory address.

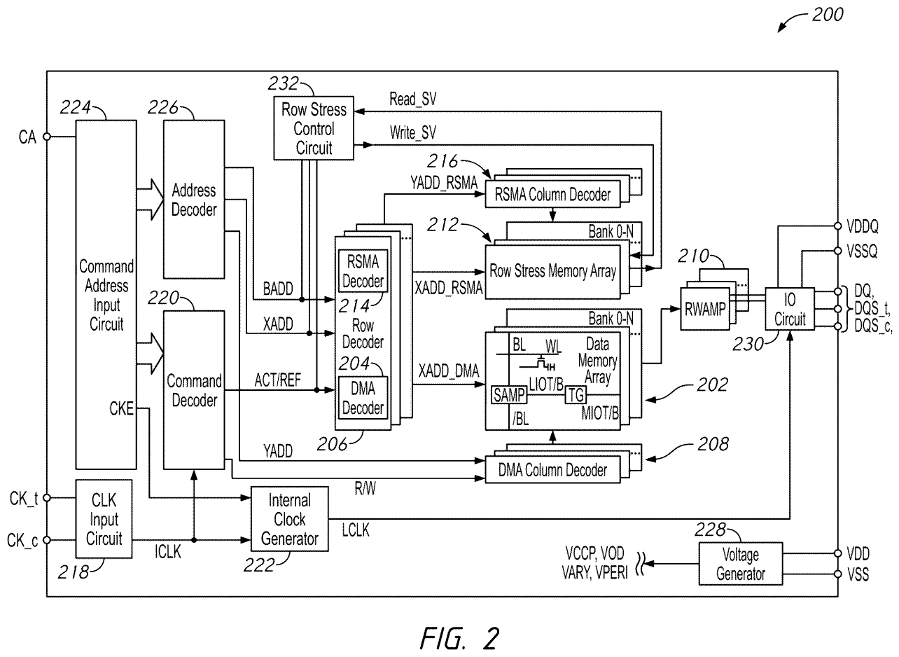

FIG. 2 illustrates a block diagram of a semiconductor device 200 according to an embodiment of the disclosure. The semiconductor device 200 may include, without limitation, a memory device such as a DRAM. The semiconductor device 200 includes a data memory array (DMA) 202 that is configured to store data. The DMA 202 is shown as including a plurality of memory banks. In the embodiment of FIG. 2, the DMA 202 is shown as including memory banks BANK0-N. Each memory bank includes a plurality of word lines WL, a plurality of bit lines BL and /BL, and a plurality of memory cells MC arranged at intersections of the plurality of word lines WL and the plurality of bit lines BL and /BL. Selection of the word line WL is performed by a DMA decoder circuit 204 in a row decoder 206 and selection of the bit lines BL and /BL is performed by a DMA column decoder 208. The bit lines BL and /BL are coupled to a respective sense amplifier (SAMP). Read data from the bit line BL or /BL is amplified by the sense amplifier SAMP and transferred to read/write amplifiers (RWAMP) 210 over complementary local data lines (LIOT/B), transfer gate (TG), and complementary main data lines (MIOT/B). Conversely, write data output from the read/write amplifiers 210 is transferred to the sense amplifier SAMP over the complementary main data lines MIOT/B, the transfer gate TG, and the complementary local data lines LIOT/B, and written in the memory cell MC coupled to the bit line BL or /BL.

A row stress memory array (RSMA) 212 is configured to store stress values that are associated with rows in the DMA 202. The RSMA 212 is shown as including a plurality of memory banks. In the embodiment of FIG. 2, the RSMA 212 is shown as including the same number of memory banks that are included in the DMA 202 (e.g., BANK0-N), although other embodiments are not limited to this configuration. Additionally, the RSMA 212 may be implemented similar to the DMA 202. For example, each memory bank in the RSMA 212 can include a plurality of word lines WL, a plurality of bit lines BL and /BL, and a plurality of memory cells MC arranged at intersections of the plurality of word lines WL and the plurality of bit lines BL and /BL. Selection of the word line WL is performed by an RSMA decoder circuit 214 of the row decoder 206 and selection of the bit lines BL and /BL is performed by an RSMA column decoder 216.

In the illustrated embodiment, the row decoder 206 includes a respective row decoder for each memory bank in the DMA 202 and/or the RSMA 212, and each respective row decoder 206 includes the DMA decoder 204 and the RSMA decoder 214. Similarly, the DMA column decoder 208 includes a respective column decoder for each memory bank of the DMA 202. The RSMA column decoder 216 includes a respective column decoder for each memory bank of the RSMA 212.

The semiconductor device 200 may employ a plurality of external terminals that include command and address (CA) terminals coupled to a command/address bus to receive commands and addresses (e.g., the CA bus 108 in FIG. 1). The external terminals may further include clock terminals to receive clocks CK_t and CK_c, and data clocks DQS_t and DQS_c, data terminals DQ, and power supply terminals to receive power supply potentials VDD, VSS, VDDQ, and VSSQ.

The clock terminals are supplied with external clocks CK_t and CK_c that are provided to a CLK input circuit 218. The external clocks may be complementary. The CLK input circuit 218 generates an internal clock ICLK based on the CK_t and CK_c clocks. The ICLK clock is provided to a command decoder 220 and to an internal clock generator 222. The internal clock generator 222 provides various internal clocks LCLK based on the ICLK clock. The LCLK clocks may be used for timing operation of various internal circuits.

The CA terminals may be supplied with commands and memory addresses. A command/address (CA) input circuit 224 receives command signals and address signals for the commands and memory addresses. The memory addresses supplied to the CA terminals are transferred, via the CA input circuit 224, to an address decoder 226. The address decoder 226 receives the address and supplies a decoded row address XADD to the row decoder 206 and a decoded column address YADD to the DMA column decoder 208. In some embodiments, the address decoder 226 also supplies a decoded bank address BADD to the row decoder 206.

The CA terminals may be supplied with commands. Examples of commands include access commands for accessing the DMA 202, such as activate commands, read commands for performing read operations, write commands for performing write operations, as well as other commands and operations. The commands may be provided as internal command signals to the command decoder 220 via the CA input circuit 224. The command decoder 220 includes circuits to decode the internal command signals to generate various internal signals and commands for performing operations. For example, the command decoder 220 may provide a row command signal ACT to select or activate a word line in the DMA 202, a column command signal R/W to select a bit line in the DMA 202, and a refresh command signal REF to refresh memory cells of the DMA 202.

The power supply terminals are supplied with power supply potentials VDD and VSS. The power supply potentials VDD and VSS are supplied to an internal voltage generator circuit 228. The internal voltage generator circuit 228 generates various internal potentials VCCP, VOD, VARY, VPERI, and the like based on the power supply potentials VDD and VSS supplied to the power supply terminals. The internal potential VCCP is mainly used in the row decoder 206, the internal potentials VOD and VARY are mainly used in the sense amplifiers (SAMP), and the internal potential VPERI is used in many peripheral circuit blocks.

The power supply terminals are also supplied with power supply potentials VDDQ and VSSQ. The power supply potentials VDDQ and VSSQ are supplied to the input/output circuit 230. The power supply potentials VDDQ and VSSQ supplied to the power supply terminals may be the same potentials as the power supply potentials VDD and VSS supplied to the power supply terminals in an embodiment of the disclosure. The power supply potentials VDDQ and VSSQ supplied to the power supply terminals may be different potentials from the power supply potentials VDD and VSS supplied to the power supply terminals in another embodiment of the disclosure. The power supply potentials VDDQ and VSSQ supplied to the power supply terminals are used for the input/output circuit 230 so that power supply noise generated by the input/output circuit 230 does not propagate to the other circuit blocks.

Read data is read from a memory cell in the DMA 202 corresponding to a bank address BADD, a row address XADD and a column address YADD when an activate command and read command are received, and the row address XADD and the column address YADD are timely supplied with the activate command and/or the read command. The read command is received by the command decoder 220, which provides internal command signals so that read data from the DMA 202 is provided to the read/write amplifiers 210. The read data is output to outside from the data terminals DQ via the input/output circuit 230. The DQS_t and DQS_c clocks are provided externally from clock terminals for timing the provision of the read data by the input/output circuit 230. The data terminals DQ include several separate terminals, each providing a bit of data synchronized with a clock edge of the DQS_t and DQS_c clocks.

Write data supplied to the data terminals DQ is written to a memory cell in the DMA 202 corresponding to a bank address BADD, a row address XADD and a column address YADD when an activate and a write command are received, and the row address XADD and the column address YADD are timely supplied with the activate command and/or the write command. The write command is received by the command decoder 220, which provides internal command signals so that the write data is received by input receivers in the input/output circuit 230. DQS_t and DQS_c clocks are also provided to the external clock terminals (e.g., by a controller) for timing the receipt of the write data by the input receivers of the input/output circuit 230. The write data is supplied via the input/output circuit 230 to the read/write amplifiers 210, and by the read/write amplifiers 210 to the DMA 202 to be written into the memory cell MC. As previously described, the data terminals DQ include several separate terminals. With reference to a write operation, each data terminal DQ concurrently receives a bit of data synchronized with a clock edge of the DQS_t and DQS_c clocks

As described earlier, the row decoder 206 receives decoded row addresses XADD from the address decoder 226. The DMA decoder 204 includes circuitry to decode each XADD to determine a row address XADD_DMA to be accessed in the DMA 202. The RSMA decoder 214 includes circuitry to decode each XADD to determine a row address XADD_RSMA and one or more column addresses YADD_RSMA to be accessed in the RSMA 212. In some embodiments, the row address XADD includes multiple bits that define the row address XADD_DMA to be accessed in the DMA 202. The multiple bits of the row address XADD may further be used to define the row address XADD_RSMA to be accessed in the RSMA 212, and to define one or more column addresses YADD_RSMA to be accessed in the RSMA 212. For example, the multiple bits of the row address XADD may be used as a first set of bits defining the row address XADD_DMA, and the multiple bits of the row address XADD may include a second set of bits defining the row address XADD_RSMA and include a third set of bits defining the one or more column addresses YADD_RSMA. The bits in the second set of bits and the third set of bits differ from each other in some embodiments.

In other embodiments, the row address XADD includes multiple bits that can be used to determine the row address XADD_DMA, and the multiple bits of the row address XADD may further be used to define the row address XADD_RSMA, one or more column addresses YADD_RSMA, and one or more sub-rows to be accessed in the RSMA 212. In some embodiments, the row address XADD includes multiple bits that may be used to determine the row address XADD_DMA, and the multiple bits of the row address XADD may further be used to define the row address XADD_RSMA and one or more column addresses YADD_RSMA. Bits of the row address XADD_RSMA and/or the column address(es) YADD_RSMA can be used to define one or more sub-rows to be accessed in the RSMA 212.

Each activation of a row (i.e., a word line WL) in the DMA 202 may adversely impact (referred to herein as stress) one or more nearby rows. For example, an activation of a row can increase the rate of decay of the charge stored in the memory cells in one or more nearby rows. Embodiments disclosed herein provide techniques for tracking and monitoring the stress on nearby rows by storing stress values in the RSMA 212. When a row in the DMA 202 is accessed, the stress values for one or more rows that are near the accessed row are adjusted and stored in the RSMA 212. In one embodiment, the adjustments to the stress values are weighted based on a proximity to the accessed row in the DMA 202. For example, the stress value for a row that is one row away from (e.g., next to) an accessed row may be adjusted or incremented by a first adjustment value (e.g., +4) while the stress value for a row that is two rows away from the accessed row may be adjusted or incremented by a second adjustment value (e.g., +1), where the second adjustment value is less than the first adjustment value. A row in the DMA 202 is refreshed when the stress value for that row equals or exceeds a threshold. The stress value for a stressed row that has a stress value that equals or exceeds the threshold is reset to an initial stress value (e.g., zero) or reduced by a particular amount and stored in the RSMA 212 when the row is refreshed. Additionally, since an access operation has the same effect on a row as a refresh operation, the stress value for the accessed row is reduced or reset and the initial stress value is stored in the RSMA 212.

A row stress control circuit 232 is configured to receive the stress values from the RSMA 212 (Read_SV) for the accessed row and the one or more rows that are stressed by accessing the accessed row, determine and apply adjustment values to the stress values for the one or more stressed rows, and store the adjusted stress values in the RSMA 212. The row stress control circuit 232 is configured to determine if the adjusted stress values equal or exceed the threshold. When a stress value equals or exceeds the threshold, the stressed row that corresponds to the stress value that equals or exceeds the threshold is refreshed, and the circuitry in the row stress control circuit 232 is configured to write a reduced or an initial stress value for that stressed row to the RSMA 212. Since the access operation on the accessed row is similar to a refresh operation, the row stress control circuit 232 is configured to adjust the stress value for the accessed row to a reduced or an initial stress value and store the reduced or initial stress value in the RSMA 212. In some instances, the amount of the reduction of the stress value may be weighted based on a proximity to the accessed row.

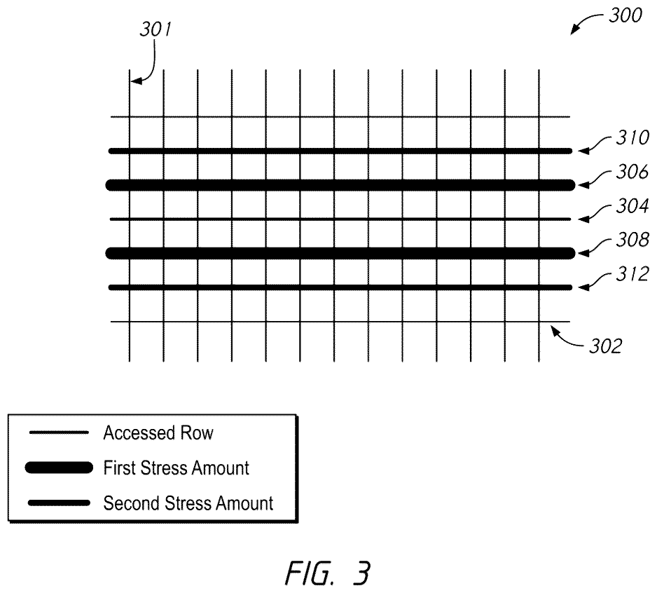

FIG. 3 illustrates a portion of a memory array 300 according to an embodiment of the disclosure. The portion of the memory array 300 may be included in the DMA 202 shown in FIG. 2. As described earlier, the memory array 300 includes bit lines 301 (e.g., BL and /BL lines) and word lines 302. A word line associated with the row 304 is activated to access the row 304 in the memory array 300. Accessing the row 304 can produce stress on the rows near the accessed row 304. A stress value that represents the stress is determined for one or more rows that are proximate to the accessed row 304. The one or more rows can be one row away from (e.g., next to) the accessed row 304 and/or may be two or more rows away from the accessed row 304. For example, in one embodiment, a stress value for the row 306 one row away from the accessed row 304 on one side of the accessed row 304 is determined and a stress value for the row 308 one row away from the accessed row 304 on the other side of the accessed row 304 is determined. The rows 306, 308 are also referred to as the +/−1 rows. In some embodiments, stress values for the rows 306, 308 are determined, and additionally, a stress value for the row 310 two rows away from the accessed row 304 (i.e., next to the +1 row 306) on one side of the accessed row 304 is determined and a stress value for the row 312 two rows away from the accessed row 304 (i.e., next to the −1 row 308) is determined. The rows 310, 312 are also referred to as the +/−2 rows. In some embodiments, stress values may be determined for one or more of rows 306, 308, 310, 312 and/or for additional rows in the memory array 300.

In some instances, the amount of stress experienced by a nearby row varies based on the proximity of that row to the accessed row. As shown in FIG. 3, the rows 306, 308 (the +/−1 rows) may experience a first amount of stress (represented by thicker line) and the rows 310, 312 (the +/−2 rows) can experience a second amount of stress (represented by thick line), where the first amount of stress is greater than the second amount of stress. The rows 306, 308 can experience a greater amount of stress because the rows 306, 308 are physically closer to the accessed row 304. In such instances, the stress values determined for the rows 306, 308 may be different from the stress values determined for the rows 310, 312 when the row 304 is accessed. In other words, stress values, and the adjustment values for the stress values, can be weighted based on the proximity to an accessed row. As such, the adjustment values applied to the stress values for the rows 306, 308 can be larger than the adjustment values applied to the stress values for the rows 310, 312. For example, the adjustment values applied to the stress values associated with the rows 306, 308 can be a first adjustment value (e.g., +4) and the adjustment values for the stress values associated with the rows 310, 312 can be a different second adjustment value (e.g., +1).

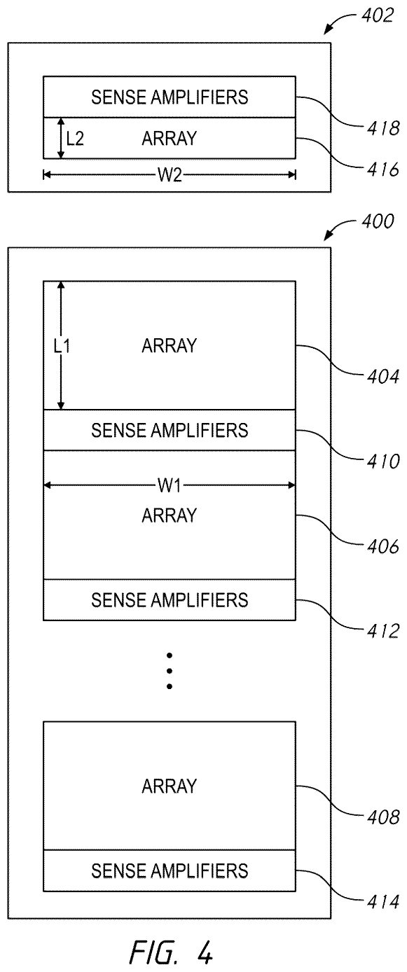

FIG. 4 illustrates a block diagram of examples of a DMA 400 and an RSMA 402 according to an embodiment of the disclosure. In some implementations, the DMA 400 may be implemented as the DMA 202 shown in FIG. 2 and the RSMA 402 can be implemented as the RSMA 212 shown in FIG. 2. The DMA 400 can include multiple arrays of memory cells 404, 406, 408. The DMA 400 also includes blocks of sense amplifiers 410, 412, 414.

The RSMA 402 includes an array of memory cells 416 and a block of sense amplifiers 418. In one embodiment, the number of memory cells 416 in the RSMA 402 is less than the number of memory cells included in arrays of memory cells 404, 406, 408 in the DMA 400. For example, the width W2 of memory cells of the array of memory cells 416 may be the same as the width W1 of memory cells of the multiple arrays of memory cells 404, 406, 408 while the length L2 of memory cells of the array of memory cells 416 can be less than the length L1 of memory cells of the multiple arrays of memory cells 404, 406, 408. In some embodiments, the number of columns of memory cells included in the arrays of memory cells 404, 406, 408 in the DMA 400 and the number of columns of memory cells included in the array of memory cells 416 in the RSMA 402 are the same, but the number of rows of memory cells included in the array of memory cells 416 is less than the number of rows of memory cells included in the arrays of memory cells 404, 406, 408. In other embodiments, the number of columns of memory cells included in the arrays of memory cells 404, 406, 408 in the DMA 400 and the number of columns of memory cells included in the array of memory cells 416 in the RSMA 402 can differ and/or the number of rows of memory cells included in the array of memory cells 416 and the number of rows of memory cells included in the arrays of memory cells 404, 406, 408 may be the same.

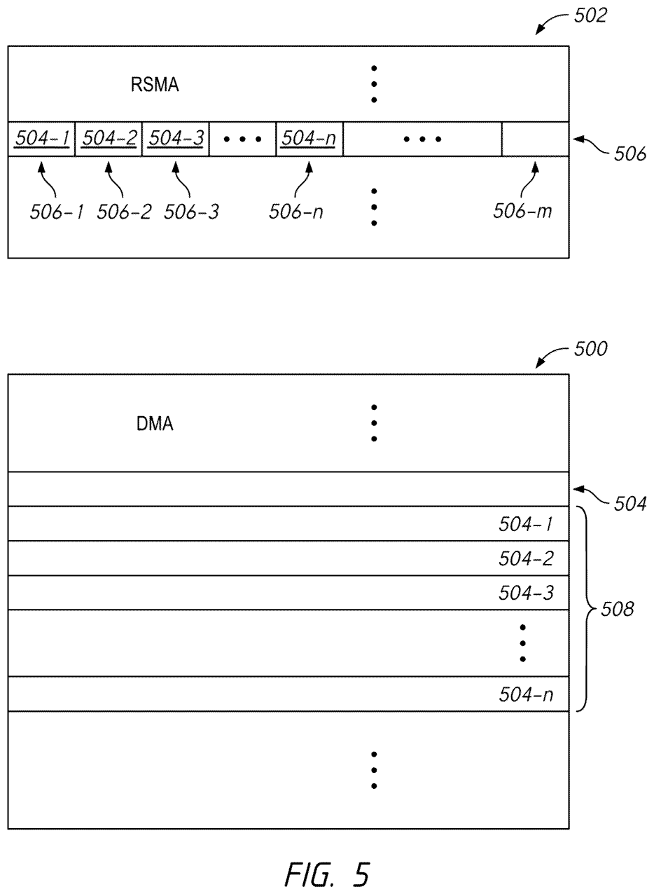

FIG. 5 illustrates a block diagram of example arrangements for a DMA 500 and an RSMA 502 according to an embodiment of the disclosure. The DMA 500 includes multiple rows 504 and the RSMA 500 includes multiple rows 506. Each row 506 in the RSMA 502 is divided into sub-rows 506-1, 506-2, . . . , 506m, and the sub-rows store stress values that are associated with the rows 504 in the DMA 500. In the illustrated embodiment, the stress values associated with a number of rows 504-1, 504-2, 504-3, . . . , 504-n in the DMA 500 are stored in respective sub-rows 506-1, 506-2, 506-3, . . . , 506-n in the RSMA 502. In other embodiments, the stress values associated with the rows 504-1, 504-2, 504-3, . . . , 504-n may be stored in one sub-row in the RSMA 502, or the stress values associated with the rows 504-1, 504-2, 504-3, . . . , 504-n can be stored in sub-rows in multiple rows in the SMA 502.

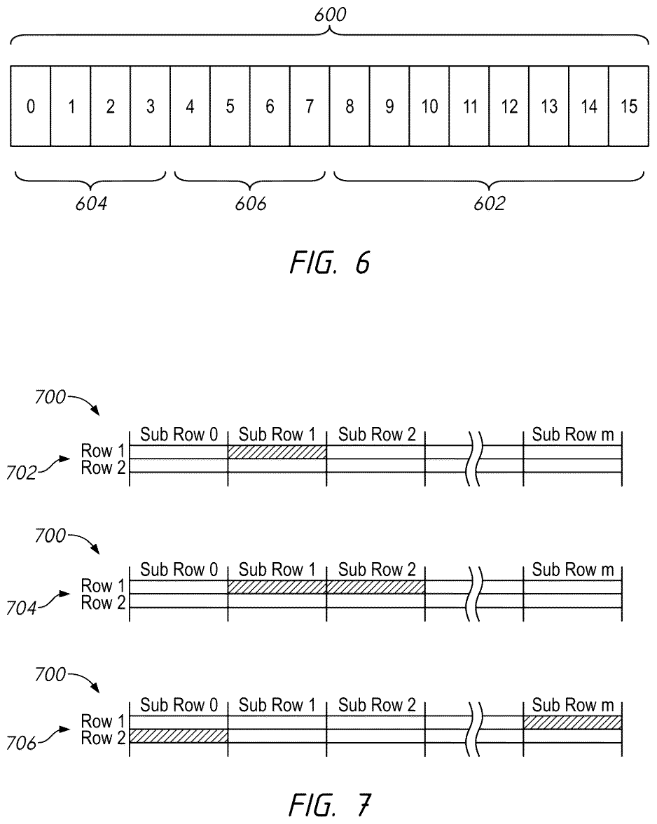

FIG. 6 illustrates an example row address 600 according to an embodiment of the disclosure. The row address 600 can be the decoded row address XADD shown in FIG. 2 in some embodiments. The row address 600 is shown as a sixteen-bit address, although other embodiments are not limited to this configuration. The row address 600 is received by a row decoder and used to access a row in a DMA (e.g., the row decoder 206 and the DMA 202 of FIG. 2). The bits of the row address 600 are used to identify the row in the DMA to be accessed. Additionally, the bits of the row address are used to identify a location in the RSMA that stores a stress value associated with the row in the DMA to be accessed. For example, a first set of bits 602 within the row address 600 provides an address for a particular row in an RSMA (e.g., the RSMA 212 of FIG. 2). A second set of bits 604 provides an address for a particular sub-row within the particular row in the RSMA. A third set of bits 606 provides an address for the bit lines for one or more memory cells within the particular sub-row in the RSMA. In the illustrated embodiment, the sets of bits 602, 604, 606 comprise distinct sets of bits, but other embodiments are not limited to this arrangement.

In other embodiments, the first set of bits 602 within the row address 600 can provide an address for a particular row in the RSMA. A second set of bits, such as the combination of 604 and 606, may provide an address for the bit lines for one or more memory cells within the particular row in the RSMA. In yet other embodiments, the first set of bits 602 within the row address 600 can provide an address for a particular row in the RSMA. A second set of bits, such as the combination of 604 and 606, may provide an address for the bit lines for one or more memory cells in the RSMA. Bits within the first set of bits 602 and/or the second set of bits (e.g., combined 604 and 606) can provide an address for one or more sub-rows in the RSMA.

FIG. 7 illustrates different example arrangements for stress values in a portion of an RSMA 700 according to an embodiment of the disclosure. The RSMA 700 includes Row 1 and Row 2. Both Row 1 and Row 2 are divided into sub-rows sub-row 0, sub-row 1, sub-row 2, . . . , sub-row m, where m is greater than zero. Each of sub-row 0, sub-row 1, sub-row 2, . . . , and sub-row m can include multiple memory cells (not shown). In the illustrated embodiment, each of sub-row 0, sub-row 1, sub-row 2, . . . , sub-row m can store one or more stress values.

In the first arrangement 702, the stress values associated with the accessed and the stressed rows in the DMA are stored in sub-row 1 in Row 1. In the second arrangement 704, the stress values associated with the accessed and the stressed rows in the DMA are stored in sub-row 1 and in sub-row 2 in Row 1. In the third arrangement 706, some of the stress values associated with the accessed and the stressed rows in the DMA are stored in sub-row m in Row 1 and some of the stress values are stored sub-row 0 in Row 2. Thus, the stress values associated with the accessed and the stressed rows in the DMA can be stored in one sub-row in one row in the RSMA 700, in multiple sub-rows in one row in the RSMA 700, or in one or more sub-rows in multiple rows in the RSMA 700. In a non-limiting nonexclusive embodiment, the stress values are associated with an accessed row, the +/−1 rows, and the +/−2 rows.

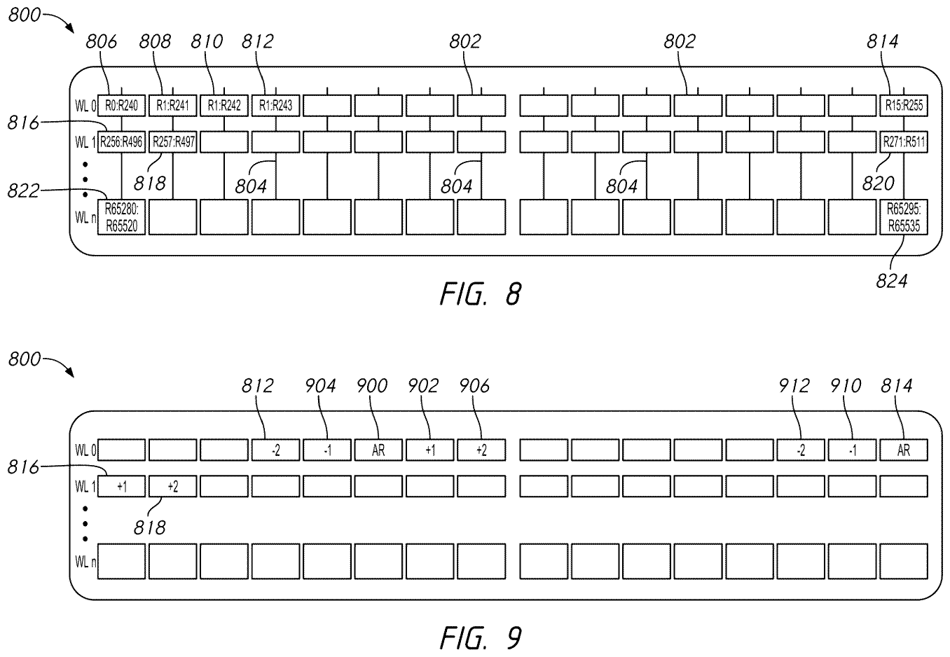

FIG. 8 illustrates another example arrangement for stress values in an RSMA 800 according to an embodiment of the disclosure. The RSMA 800 includes word lines WL0-WLn (referred to as rows WL0-WLn). Each row WL0-WLn is divided into sub-rows 802. Each sub-row 802 includes multiple memory cells (not shown). Bit lines for each memory cell (e.g., BL and /BL) are connected to each memory cell in each sub-row. For simplicity, one bit line 804 that represents the multiple bit lines is shown for the sub-rows 802.

In a non-limiting nonexclusive example, a DMA includes 65536 rows, the stress value for each row in the DMA is stored in the RSMA 800 using sixteen bits, each sub-row 802 in the RSMA 800 includes two hundred and fifty-six bits (i.e., each sub-row 802 stores sixteen stress values), each row WL0-WLn in the RSMA 800 includes 16 sub-rows (i.e., each row WL0-WLn includes four thousand and ninety-six bits), and the RSMA 800 includes two hundred and fifty-six rows WL0-WL255 (i.e., n equals 255).

In some instances, storing the stress values for sequential rows in a DMA in a single sub-row can be challenging due to the signal lines used to access the memory cells in the sub-row and the signal lines used to read and write stress values to the memory cells in the sub-row. The example arrangement shown in FIG. 8 staggers the stress values for sequential rows in the DMA across the sub-rows in the RSMA 800. Each sub-row stores stress values for sixteen rows in a DMA, with the rows separated from each other by a count of sixteen. For example, the first sub-row 806 in the first row WL0 in the RSMA 800 stores stress values for rows 0, 16, 32, 48, 64, 80, 96, 112, 128, 144, 160, 176, 192, 208, 224, and 240 in the DMA (R0:R240). The second sub-row 808 in the first row WL0 in the RSMA 800 stores stress values for rows 1, 17, 33, 49, 65, 81, 97, 113, 129, 145, 161, 177, 193, 209, 225, and 241 in the DMA (R1:R241). The third sub-row 810 in the first row WL0 in the RSMA 800 stores stress values for rows 2, 18, 34, 50, 66, 82, 98, 114, 130, 146, 162, 178, 194, 210, 226, and 242 in the DMA (R2:R242). The fourth sub-row 812 in the first row WL0 in the RSMA 800 stores stress values for rows 3, 19, 35, 51, 67, 83, 99, 115, 131, 147, 163, 179, 195, 211, 227, and 243 in the DMA (R3:R243). This storage pattern continues through the sub-rows in the first row WL0 up to the sixteenth sub-row 814, which stores stress values for rows 15, 31, 47, 63, 79, 95, 111, 127, 143, 159, 175, 191, 207, 223, 239, and 255 in the DMA (R15:R255).

The first sub-row 816 in the second row WL1 in the RSMA 800 stores stress values for rows 256, 272, 288, 304, 320, 336, 352, 368, 384, 400, 416, 432, 448, 464, 480, and 496 in the DMA (R256:R496). The second sub-row 818 in the second row WL1 in the RSMA 800 stores stress values for rows 257, 273, 289, 305, 321, 337, 353, 369, 385, 401, 417, 433, 449, 465, 481, and 497 in the DMA (R257:R497). This storage pattern continues through the sub-rows in the second row WL1 in the RSMA 800 up to the sixteenth sub-row 820 which stores stress values for rows 271, 287, 303, 319, 335, 351, 367, 383, 399, 415, 431, 447, 463, 479, 495, and 511 in the DMA (R271:R511).

The storage pattern continues through the sub-rows in the subsequent rows in the RSMA 800 up to the last row WLn. The first sub-row 822 in the last row WLn in the RSMA 800 stores stress values for rows 65280, 65296, 65312, 65328, 65344, 65360, 65376, 65392, 65408, 65424, 65440, 65456, 65472, 65488, 65504, and 65520 in the DMA (R65280:R65520). This storage pattern continues through the sub-rows in the last row WLn in the RSMA 800 up to the sixteenth sub-row 824, which stores stress values for rows 65295, 65311, 65327, 65343, 65359, 65375, 65391, 65407, 65423, 65439, 65455, 65471, 65487, 65503, 65519, and 65535 in the DMA (R65295:R65535).

The example arrangement shown in FIG. 8 can provide several advantages. One advantage is the lengths of the word lines (i.e., rows WL0-WLn) in the RSMA can be shorter compared to the lengths of the word lines in the DMA. Additionally, or alternatively, the lengths of the bit lines may be shorter compared to the lengths of the bit lines in an DMA. In some implementations, the lengths of the local input/output lines can be shorter and/or the lengths of the global input/output lines may be shorter compared to the lengths of the local input/output lines and the global input/output lines in the DMA. For example, the lengths of the word lines may be shorter by one half (½), the lengths of the bit lines can be one fifth (⅕) shorter, the lengths of the local input/output lines may be shorter by one half (½), and the lengths of the global input/output lines can be one fortieth ( 1/40).

FIG. 9 illustrates a process of accessing stress values in the RSMA 800 shown in FIG. 8 according to an embodiment of the disclosure. A row address to access a row in a DMA is received and a row decoder determines the row and column addresses in the RSMA 800 based on the received row address. For example, the received row address may be configured as the row address 600 shown in FIG. 6 and the row decoder 206 shown in FIG. 2 can determine the row and column addresses in the RSMA 800. In one example, the row to be accessed in the DMA is row 5.

A stress value that is associated with the accessed row 5 (AR) is read out of the sub-row 900 in the first row WL0 of the RSMA 800. Since an access operation has the same effect as a refresh operation on a row, the stress value is reset to an initial stress value (e.g., zero) and then written to the sub-row 900. The stress values associated with the rows that experience stress due to the access of row 5 are also read out of the RSMA 800. In FIG. 9, the stress values are associated with the +1 row, the −1 row, the +2 row, and the −2 row in the DMA. The stress value associated with the +1 row is stored in sub-row 902, the stress value associated with the −1 row is stored in sub-row 904, the stress value associated with the +2 row is stored in sub-row 906, and the stress value associated with the −2 row is stored in sub-row 812. The stored stress values are read and are adjusted and written into the sub-rows 902, 904, 906, 812.

In another example, the row to be accessed in the DMA is row 15. A stress value that is associated with the accessed row 15 (AR) is read out of the sub-row 814 in the first row WL0 in the RSMA 800. Since an access operation has the same effect as a refresh operation on a row, the stress value is reset to an initial stress value (e.g., zero) and then written to the sub-row 814. The stress values associated with the rows that experience stress due to the access of row 15 are also read out of the RSMA 800. In FIG. 9, the stress values are associated with the +1 row, the −1 row, the +2 row, and the −2 row. The stress value associated with the +1 row is stored in sub-row 816 in the second row WL1, the stress value associated with the-1 row is stored in sub-row 910 in the first row WL0, the stress value associated with the +2 row is stored in sub-row 818 in the second row WL1, and the stress value associated with the −2 row is stored in sub-row 912 of the first row WL0. The stored stress values are read and are adjusted and written into the sub-rows 816, 818, 910, 912.

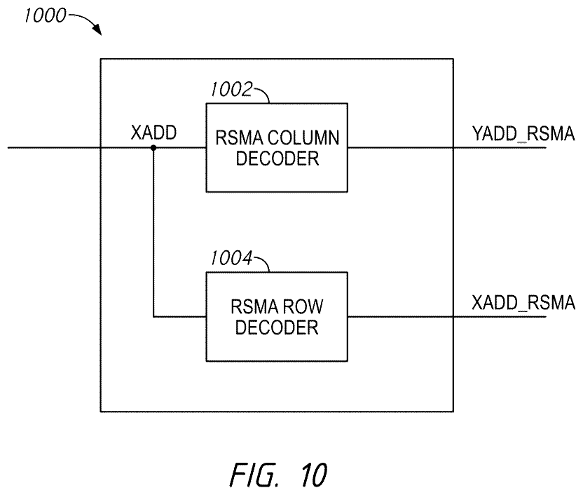

FIG. 10 illustrates a block diagram of an example RSMA decoder 1000 according to an embodiment of the disclosure. In some implementations, the RSMA decoder 1000 may be implemented as the RSMA decoder 214 shown in FIG. 2. The RSMA decoder 1000 includes an RSMA column decoder 1002 and an RSMA row decoder 1004. The row address XADD is received by the RSMA column decoder 1002 and the RSMA row decoder 1004. The row address XADD may be implemented as the row address 600 shown in FIG. 6 in some embodiments.

The RSMA column decoder 1002 includes circuitry to decode the row address XADD to determine one or more column addresses YADD_RSMA that are used to access one or more columns (e.g., BL and /BL) in an RSMA (e.g., the RSMA 212 in FIG. 2). For example, in the embodiment shown in FIG. 9, the RSMA column decoder 1002 is configured to decode the row address to determine the column address for the stress value associated with the accessed row AR in the DMA that corresponds to the row address XADD. For example, in the embodiments shown in FIG. 6 and FIG. 8, the bits 4-7 of FIG. 6 are used to determine the bit lines for the stress value associated with the accessed row AR in the DMA that corresponds to the row address XADD. Using the column address for the stress value associated with the accessed row AR, the RSMA column decoder 1002 is configured to determine the column address for the stress values that are associated with the +/−1 rows and the +/−2 rows in the DMA. For example, in some embodiments, the RSMA column decoder 1002 is configured to add one, subtract one, add two, and subtract two from the address of the column associated with the accessed row AR to determine the column addresses for the stress values that are associated with the +/−1 rows and the +/−2 rows in the DMA.

The RSMA row decoder 1004 includes circuitry to decode the row address XADD to determine the row address XADD_RSMA for the stress value associated with the accessed row AR in the DMA that corresponds to the row address XADD. For example, in the embodiments shown in FIG. 6 and FIG. 8, the RSMA row decoder 1004 decodes bits 0-3 and bits 8-15 in the row address 600 (XADD) to determine the sub-row address and the row address in the RSMA (XADD_RSMA) that is associated with the stress value for the accessed row AR in the DMA. Using the sub-row and row addresses for the stress value associated with the accessed row AR, the RSMA row decoder 1004 is configured to determine the sub-row and row addresses for the stress values that are associated with the +/−1 rows and the +/−2 rows in the DMA. For example, in some embodiments of the disclosure, the RSMA row decoder 1004 is configured to add one, subtract one, add two, and subtract two from the address of the sub-row to determine the sub-row addresses for the stress values that are associated with the +/−1 rows and the +/−2 rows in the DMA.

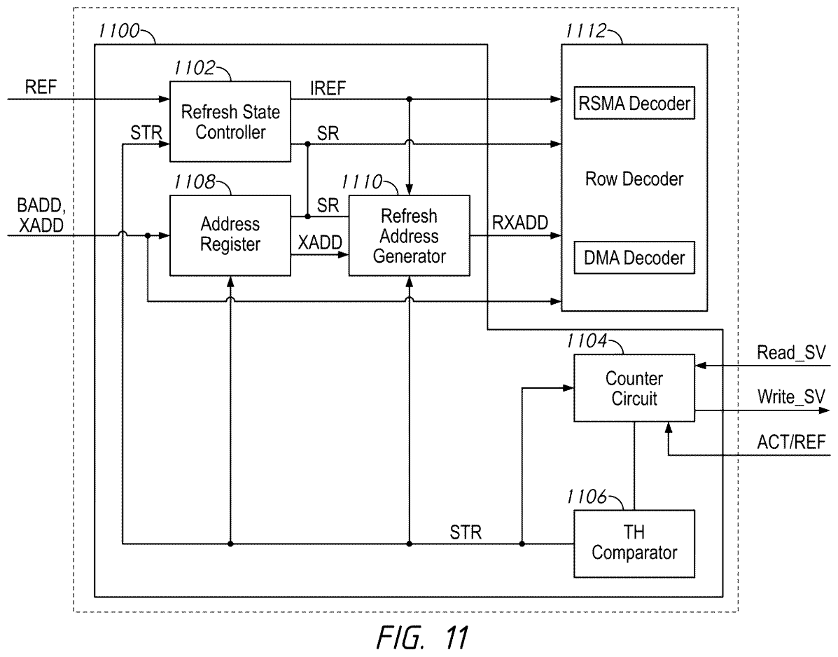

FIG. 11 illustrates a block diagram of an example row stress control circuit 1100 according to an embodiment of the disclosure. The row stress control circuit 1100 and the row decoder 1112 can be implemented as the row stress control circuit 232 and the row decoder 206 shown in FIG. 2. The dashed line around the row stress control circuit 1100 and the row decoder 1112 is shown to represent that in certain embodiments, each of the components within the dashed line may correspond to a particular bank of memory, and that these components may be repeated for each of the banks of memory. Thus, there may be multiple row stress control circuits 1100 and row decoders 1112. In other embodiments, the components shown within the dashed line may be associated with all of the memory banks. For the sake of brevity, components for only a single bank are described.

The row decoder 1112 is configured to activate rows in a DMA, refresh rows in the DMA during auto-refresh operations and refresh stressed rows in the DMA when the stress values associated with the stressed rows equal or exceed a threshold. In one embodiment, the row decoder 1112 determines the row in the DMA to be accessed based on row address XADD and determines the memory locations in the RSMA that are associated with the accessed row and the stressed rows in the DMA based on the row address XADD. The row stress control circuit 1100 includes a refresh state controller circuit 1102, a counter circuit 1104, a threshold (TH) comparator circuit 1106, an address register 1108, and a refresh address generator circuit 1110. As described previously, stress values stored in the RSMA are adjusted based on accesses to rows in the DMA. Refresh operations and activate operations both access rows in the DMA. Accordingly, stress values are adjusted based on both the refresh and the activate operations.

The counter circuit 1104 is configured to receive the refresh signal REF and the activate signal ACT. Based on active ACT and REF signals, and the row decoder 1112 accessing a row in the DMA and associated stress values in the RSMA, the counter circuit 1104 is configured to receive the stress values (Read_SV) from the RSMA that are associated with the accessed row in the DMA and the stressed rows in the DMA. The counter circuit 1104 is configured to adjust the stress values associated with the accessed row and the stressed rows. For example, the stress value associated with the accessed row can be reset to an initial stress value or reduced by a particular amount (collectively referred to as an “adjustment value”). Additionally, the stress values associated with the stressed rows can be adjusted using an adjustment amount (“adjustment value”). As discussed previously, the adjustment values for the stressed rows may be weighted based on the proximity of the stressed rows to the accessed row in the DMA. The counter circuit 1104 is configured to write the adjusted stress values (Write_SV) to the RSMA.

The TH comparator circuit 1106 is configured to compare the adjusted stress values that are associated with the stressed rows to a threshold. When one or more stress values equal or exceed the threshold, the TH comparator circuit 1106 is configured to provide an active stress signal STR to the counter circuit 1104, the address register circuit 1108, the refresh address generator circuit 1110, and the refresh state controller circuit 1102. The active stress signal STR may include positional information with each stress value that equals or exceeds the threshold with respect to the accessed row in the DMA (e.g., +/−1 or 2). The active stress signal STR can cause the stressed rows in the DMA that are associated with the stress values that equal or exceed the threshold to be refreshed. The counter circuit 1104 is configured to reset the stress value that equals or exceeds the threshold by an adjustment value and adjust the stress value associated with the accessed row in the DMA by an adjustment value and write the adjusted stress values to the RSMA.

The address register 1108 is configured to receive the bank address BANK and the row address XADD and latch the bank and row addresses in response to receiving the active stress signal STR. The address register 1108 is configured to provide the row address XADD to the refresh address generator circuit 1110. The refresh state controller circuit 1102 is configured to provide an active stress refresh signal SR to the refresh address generator circuit 1110 and the row decoder 1112 in response to receiving the active stress signal STR to cause the stressed rows in the DMA that are associated with the stress values that equal or exceed the threshold to be refreshed.

The refresh address generator circuit 1110 is configured to determine the row address(es) for the stressed rows in the DMA that are to be refreshed based on the row address XADD and the positional information in the active stress signal STR. The refresh address generator circuit 1110 is configured to provide the row addresses RXADD for the stressed rows in the DMA to be refreshed to the row decoder 1112. The row decoder 1112 is configured to refresh the stressed rows in the DMA based on the row addresses RXADD.

The refresh state controller circuit 1102 is configured to receive the active refresh signal REF and provide an active internal refresh signal IREF to the row decoder 1112 for additional refresh operations, such as auto-refresh operations. The refresh address generator circuit 1110 is configured to provide the row addresses RXADD to be refreshed in auto-refresh operations to the row decoder 1112.

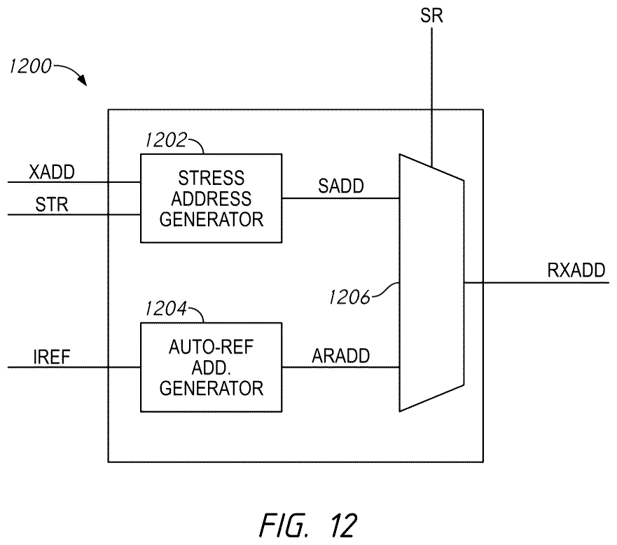

FIG. 12 illustrates a block diagram of an example refresh address generator circuit 1200 according to an embodiment of the disclosure. The refresh address generator circuit 1200 can be implemented as the refresh address generator circuit 1110 shown in FIG. 11 in some embodiments. The refresh address generator circuit 1200 includes a stress address generator circuit 1202, an auto-refresh address generator circuit 1204, and a selector circuit 1206.

The stress address generator circuit 1202 is configured to receive the row address XADD that represents a row to be accessed in the DMA and the active stress signal STR. The stress address generator circuit 1202 is configured to determine the row address XADD in the DMA that is associated with the accessed row and using the positional information in the active stress signal STR, determine the row address(es) associated with the stressed row(s) in the DMA. The stress address generator circuit 1202 provides the row address(es) associated with the stressed row(s) in the DMA to the selector circuit 1206 as the stressed address signal SADD.

The auto-refresh address generator 1204 is configured to receive the internal refresh signal IREF and provide row addresses in the DMA to be refreshed in auto-refresh operations to the selector circuit 1206 as the auto refresh address signal ARADD. The selector circuit 1206 is configured to select either the stressed address signal SADD or the auto refresh address signal ARADD. In one embodiment, the selector circuit 1206 is a multiplexer circuit that receives the stress refresh signal SR as the select signal.

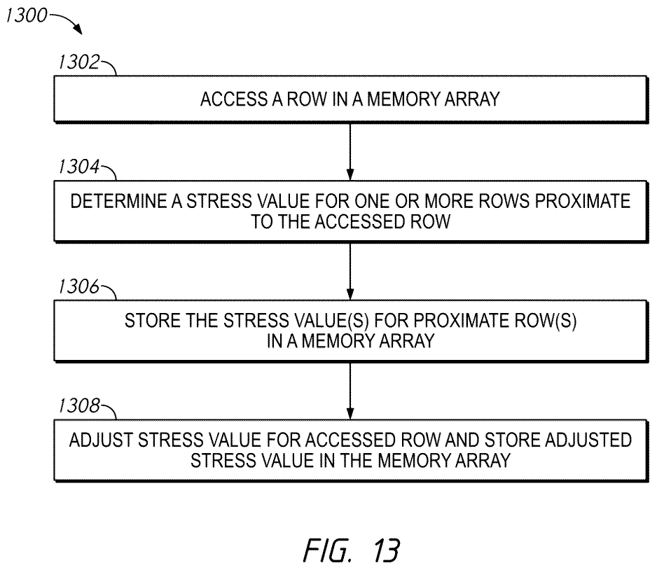

FIG. 13 illustrates a flowchart of an example method 1300 of operating a memory device according to an embodiment of the disclosure. The method is described in conjunction with accessing a row in a memory array (e.g., a DMA). The method 1300 can be performed for every row accessed in the memory array.

At block 1302, a row in the memory array is accessed. The row may be accessed based on a refresh signal or an activate signal. The refresh signal may be generated as part of a refresh operation, and the activate signal can be generated as part of an access operation (e.g., a read or write operation).

At block 1304, a stress value for one or more stressed rows that are proximate to the accessed row is determined. In one embodiment, stress values are determined for the +/−1 rows and the +/−2 rows in the DMA, although other embodiments are not limited to this implementation.

At block 1306, the stress values associated with the stressed rows are stored in a memory array. In some implementations, activating a word line is the same, or has the same effect as a refresh operation on that row. Therefore, at block 1308, the stress value associated with the accessed row can be adjusted (i.e., reduced or reset) by an adjustment value and the adjusted stress value stored in the memory array. As described earlier, in some embodiments, the stress value associated with the accessed row can be reduced by subtracting a constant value from the stress value or by writing a random value that is below the threshold to the RSMA, and the stress value(s) associated with the stressed row(s) may be reset to an initial stress value (e.g., zero).

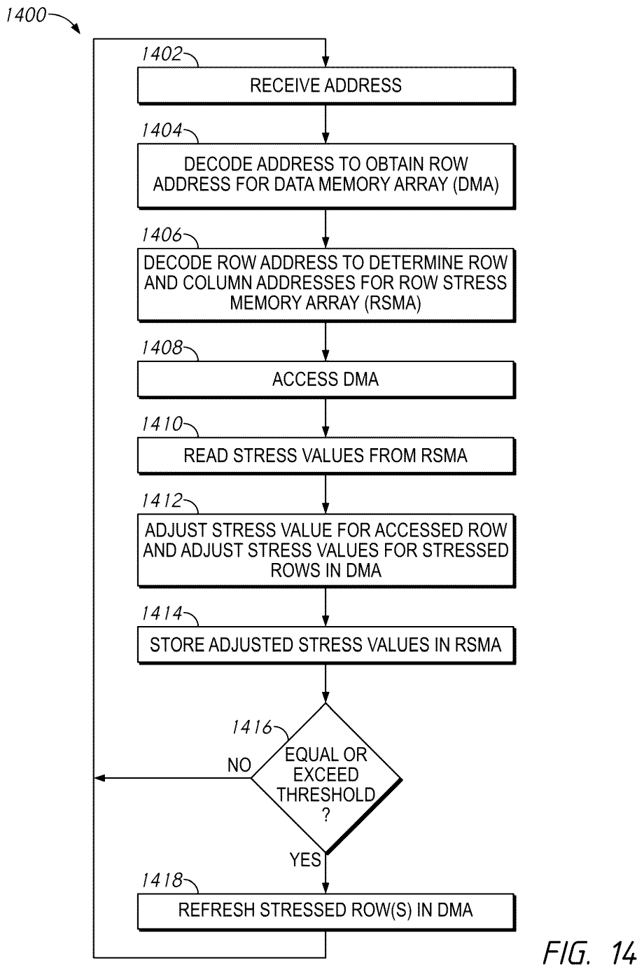

FIG. 14 illustrates a flowchart of an example method 1400 of operating a memory device according to an embodiment of the disclosure. At block 1402, an address is received by the memory device. The address may be provided to the memory device from a circuit and/or device external to the memory device (e.g., by the controller 102 of FIG. 1). At block 1404, the address is decoded to obtain a row address for a DMA (e.g., the DMA 202 of FIG. 2). In one embodiment, the address decoder 226 decodes the address and provides the row address XADD to the row decoder 206 (FIG. 2).

At block 1406, the row address for the DMA is decoded to obtain a row address and one or more column addresses for an RSMA (e.g., the RSMA 212 of FIG. 2). In one embodiment, the RSMA decoder 214 decodes the row address XADD and provides the row address XADD_RSMA to the RSMA and the column address(es) YADD_RSMA to the RSMA column decoder 216. In another embodiment, an RSMA decoder decodes the row address XADD and provides the row address and one or more sub-row addresses to the RSMA and the column address(es) to an RSMA column decoder.

At block 1408, a row of the DMA is accessed based on the row address determined at block 1404. Based on the row and column addresses determined at block 1406, stress values associated with the DMA row address are read out of the RSMA (block 1410).

At block 1412, the stress values associated with the accessed row in the DMA and the stressed rows near the accessed row in the DMA are adjusted. As described earlier, the adjustments or increments to the stress values associated with the stressed rows in the DMA can be weighted based on the proximity of the stressed rows to the accessed row in the DMA. For example, the stress values for the +/−1 rows can be adjusted or incremented by a first adjustment value (e.g., +4) and the stress values for the +/−2 rows may be adjusted or incremented by a second adjustment value (e.g., +1), where the second adjustment value is less than the first adjustment value. Additionally, at block 1412, the stress value associated with the accessed row in the DMA is adjusted by resetting the stress value to an initial value, such as zero, or by reducing the stress value by a particular amount.

At block 1414, the adjusted stress values are stored in the RSMA. At block 1416, a determination is made as to whether each adjusted stress value equals or exceeds a threshold. Based on a determination that the adjusted stress value does not equal or exceed the threshold (i.e., is below the threshold), the method passes to block 1402. Based on a determination that the adjusted stress value equals or exceeds the threshold at block 1416, the method continues at block 1418 where the stressed row in the DMA associated with the stress value that equals or exceeds the threshold is refreshed and the stress value is adjusted (i.e., reset or reduced) and stored in the RSMA. The method then returns to block 1402.

Although FIG. 13 and FIG. 14 depict blocks in a particular order, other embodiments are not limited to this implementation. Blocks can be added, omitted, rearranged, and/or some blocks may be performed in parallel. For example, blocks 1416 and 1418 may be performed in parallel for all adjusted stress values or sequentially for each adjusted stress value. Additionally, or alternatively, block 1414 can be performed after blocks 1416 and 1418.

The foregoing description, for purposes of explanation, uses specific nomenclature to provide a thorough understanding of the described embodiments. However, it will be apparent to one skilled in the art that the specific details are not required to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A method, comprising:
receiving an address for a first row of memory in a first memory array;
accessing the first row in the first memory array based on the address;
determining a stress value associated with a second row in the first memory array that is proximate to the first row in the first memory array, the stress value representing an amount of stress experienced by the second row based on accessing the first row; and
storing the stress value associated with the second row.

2. The method of claim 1, further comprising:
reading the stress value associated with the second row from a second memory array configured to store stress values;
adjusting the stress value to produce an adjusted stress value;
storing the adjusted stress value in the second memory array;
determining if the adjusted stress value equals or exceeds a threshold; and
based on a determination that the adjusted stress value is equal to or greater than the threshold, refreshing the second row in the first memory array.

3. The method of claim 2, wherein an amount of adjustment to the stress value is based on a proximity of the second row to the first row in the first memory array.

4. The method of claim 2, wherein the stress value is read from the second memory array based on a second row address and one or more second column addresses that are included in the address.

5. The method of claim 2, wherein:
each row in the second memory array is divided into a plurality of sub-rows; and
the address further comprises:
a first address associated with a sub-row in the second memory array; and
a second address associated a column in the in sub-row in the second memory array.

6. The method of claim 2, wherein:
the address is defined by a first set of bits;
the first address is defined by a second set of bits within the first set of bits;
the first address is defined by a third set of bits within the first set of bits;
the second address is defined by a fourth set of bits in the first set of bits; and
each of the second set of bits, the third set of bits, and the fourth set of bits comprise different bits within the first set of bits.

7. The method of claim 2, wherein the adjusted stress value is an initial stress value.

8. An apparatus, comprising:
a first memory array configured to store data; and
a second memory array configured to store stress values associated with rows in the first memory array,
wherein a stress value associated with a row in the first memory array represents a stress level experienced by the row from other rows in the first memory array that are accessed.

9. The apparatus of claim 8, further comprising a row decoder configured to decode a received address into a first memory array row address associated with a row in the first memory array to be accessed, a first memory array column address associated with a column in the first memory array to be accessed, and a second memory array row address associated with a row in the second memory array.

10. The apparatus of claim 8, wherein the row in the second memory array is divided into a plurality of sub-rows.

11. The apparatus of claim 10, wherein a received address for a row in the first memory array that is to be accessed is further decoded into a first address associated with a sub-row in the plurality of sub-rows and a second address associated with a column in the sub-row.

12. The apparatus of claim 8, further comprising a control circuit configured to:
receive a stress value from the second memory array that is associated with a stressed row in the first memory array based on a row access in the first memory array;
apply an adjustment value to the stress value to produce an adjusted stress value; and
store the adjusted stress value in the second memory array.

13. The apparatus of claim 12, wherein the row access is based on a received activate command or a received refresh command.

14. The apparatus of claim 13, wherein the adjustment value is determined by a proximity of the row to the accessed row in the first memory array.

15. A method, comprising:
accessing a first row in a first memory array based on a received row address for the first memory array;
receiving a stress value for a second row in the first memory array that is proximate to the first row in the first memory array;
adjusting the stress value associated with the second row to produce an adjusted stress value; and
storing the adjusted stress value.

16. The method of claim 15, wherein:
the stress value is a first stress value;
the adjusted stress value is a first adjusted stress value; and
the method further comprises:
receiving a second stress value associated with the first row in the first memory array;
adjusting the second stress value to produce a second adjusted stress value; and
storing the second adjusted stress value.

17. The method of claim 16, wherein:
adjusting the first stress value associated with the second row comprises incrementing the first stress value by an adjustment value to produce the first adjusted stress value; and
adjusting the second stress value associated with the first row comprises resetting the second stress value to an initial stress value to produce the second adjusted stress value.

18. The method of claim 17, wherein the adjustment value is weighted based on a proximity of the second row to the first row.

19. The method of claim 15, wherein:
the memory array comprises a first memory array; and
the first adjusted stress value and the second adjusted stress value are stored in a second memory array.

20. The method of claim 19, wherein the stress value is read from the second memory array based on a second row address and one or more second column addresses that are included in the received row address for the first memory array.
